(19) United States
(12) Patent Application Publication
(10) Pub. No.: US 2010/0305857 A1
(43) Pub. Date: Dec. 2, 2010

(54) Method and System for Visual Collision Detection and Estimation

(76) Inventors: Jeffrey Byrne, Philadelphia, PA (US); Raman K. Mehra, Lexington, MA (US)

Correspondence Address: David Crosby, Nixon Peabody LLP, 100 Summer Street, Boston, MA, 02110, US

(21) Appl. No.: 12/776,202

(22) Filed: May 7, 2010

Related U.S. Application Data
(60) Provisional application No. 61/176,588, filed on May 8, 2009.

(51) Int. Cl. G08G 1/16; G06K 9/00

(52) U.S. Cl. 701/301; 382/107

(57) ABSTRACT

Collision detection and estimation from a monocular visual sensor is an important enabling technology for safe navigation of small or micro air vehicles in near earth flight. In this paper, we introduce a new approach called expansion segmentation, which simultaneously detects “collision danger regions” of significant positive divergence in inertial aided video, and estimates maximum likelihood time to collision (TTC) in a correspondenceless framework within the danger regions. This approach was motivated from a literature review which showed that existing approaches make strong assumptions about scene structure or camera motion, or pose collision detection without determining obstacle boundaries, both of which limit the operational envelope of a deployable system. Expansion segmentation is based on a new formulation of 6-DOF inertial aided TTC estimation, and a new derivation of a first order TTC uncertainty model due to subpixel quantization error and epipolar geometry uncertainty. Proof of concept results are shown in a custom designed urban flight simulator and on operational flight data from a small air vehicle.

### CROSS-REFERENCE TO RELATED APPLICATIONS

This application claims any and all benefits as provided by law of U.S. Provisional Application No. 61/176,588 filed 8 May 2009 which is hereby incorporated by reference in their entirety.

### STATEMENT REGARDING FEDERALLY SPONSORED RESEARCH

This invention was made with Government support under contract (FA8651-07-C-0094) awarded by the US Air Force (AFRL/MNGI). The US Government has certain rights in the invention.

### REFERENCE TO MICROFICHE APPENDIX

Not Applicable

### BACKGROUND

1. Technical Field of the Invention

The present invention is directed to a method and system for collision detection and estimation using a monocular visual sensor to provide improved safe navigation of remotely controlled vehicles, such small or micro air vehicles in near earth flight and ground vehicles around stationary objects.

2. Description of the Prior Art

The use of Unmanned Aircraft Systems (UAS) for reconnaissance, surveillance, and target acquisition has been one of the major transformations of the Current Force during the War on Tenor. UAS of all classes have proved their value to both mounted and dismounted infantry by giving them a look ahead capability during urban and rural operations.

Operation of UAS in proximity to other manned aircraft, both within the United States and in theaters of combat worldwide, requires that the UAS is able to sense and avoid aircraft and static hazards. For example, UAS's flying “nap of the earth” risk collision with ground obstacles whose position cannot be guaranteed to be known beforehand, such as flight in city canyons and around high-rise buildings as envisioned for future homeland security operations. UAS's flying at higher altitudes risk collision with other aircraft, that may not include cooperative Traffic Collision Avoidance System (TCAS) deconfliction capability. Another compelling need for this capability is the growing demand for aerial surveillance by civilian authorities. The transition of UAS to civilian law enforcement applications has already begun, with police and sheriffs department programs in California, Florida, and Arkansas drawing intense scrutiny from the Federal Aviation Administration and pilots organizations who are concerned that the UAS will pose a hazard to civil and commercial aviation in the National Air Space (NAS). The primary concern is that UAS lack the ability to sense and avoid (S&A) other aircraft and ground hazards operating in proximity to the UAS, as a manned aircraft would.

Micro Air Vehicles (MAVs) are the next generation of unmanned aircraft systems. A MAV is a small, lightweight, and autonomous sensor which will support Intelligence, Surveillance and Reconnaissance (ISR) tasks in the smallest operational unit, which will provide unprecedented situational awareness at the platoon level. MAVs will enable such on-demand ISR tasks including: over the hill reconnaissance, perch and stare surveillance, covert imaging, biological and chemical agent detection, tagging and targeting, precision strike missions and bomb impact indication. Civil and commercial applications for MAVs are not as well developed, although potential applications are extremely broad in scope. Possible applications for MAV technology include environmental monitoring (e.g., pollution, weather, and scientific applications), forest fire monitoring, homeland security, border patrol, drug interdiction, aerial surveillance and mapping, traffic monitoring, precision agriculture, disaster relief, ad-hoc communications networks, and rural search and rescue.

These tasks require that an unmanned aircraft system (UAS) exhibit autonomous operation including collision detection and avoidance. UASs flying nap of the earth risk collision with urban obstacles whose position cannot be guaranteed as known a priori. For example, the ability to fly through city canyons and around high-rise buildings is envisioned for future homeland security operations. UAVs must include situational awareness based on sensing and perception of the immediate environment to locate collision dangers and plan an appropriate avoidance path.

Safe and routine operation of autonomous vehicles requires the robust detection of hazards in the path of the vehicle, such that these hazards can be safely avoided without causing harm to the vehicle, other objects or bystanders. Obstacle detection approaches have been successfully demonstrated on autonomous ground vehicles, notably in the DARPA grand challenge events, including extended collision free operation in both off-road and controlled urban terrain. These vehicles have sufficient size, weight and power (SWAP) capabilities to support active sensors such as LIDAR or millimeter wave RADAR, or use of a dominant ground plane to aid in visual obstacle detection.

In contrast, small or micro air vehicles (MAVs) are small, lightweight, and autonomous aerial systems that can fit in a backpack, and promise to enable on-demand intelligence, surveillance and reconnaissance tasks in a near-earth environment. To move towards routine MAV flight in a near earth environment, we first must demonstrate an “equivalent level of safety” to a human pilot using appropriate sensors for the platform. Unlike ground vehicles, MAVs introduce aggressive maneuvers which couple full 6-DOF (degrees of freedom) platform motion with sensor measurements, and feature significant SWAP constraints that limit the use of active sensors. Even those active sensors that have potential for deployment on small UAVs can take away SWAP required for the payload to achieve the primary mission, and such approaches will not scale to the smallest MAVs. Furthermore, the wingspan limitations of MAVs limit the range resolution of stereo configurations, therefore an appropriate sensor for collision detection on a MAV is monocular vision. While monocular collision detection has been demonstrated in controlled flight environments, it remains a challenging problem due to the low false alarm rate needed for practical deployment and the high detection rate requirements for safety.

The dominant approaches in the literature for monocular visual collision detection and estimation can be summarized in four categories: structure from motion, ground plane methods, flow divergence and insect inspired methods.

Structure from motion (SFM) is the problem of recovering the motion of the camera and the structure of the scene from images generated by a moving camera. SFM techniques provide a sparse or dense 3D reconstruction of the scene up to an unknown scale and rigid transformation, which can be used for obstacle detection when combined with an independent scale estimate for metric reconstruction, such as from inertial navigation to provide camera motion or from a known scene scale. Modern structure from motion techniques generate impressive results for both online sequential and offline batch large scale outdoor reconstruction. Recent applications relevant to this investigation include online sparse reconstruction during MAV flight for downward looking cameras, and visual landing of helicopters. However, SFM techniques consider motion along the camera's optical axis as found in a collision scenario to be degenerate due to the small baseline, which results in significant triangulation uncertainty near the focus of expansion which must be modeled appropriately for usable measurements.

Ground plane methods, also known as horopter stereo, stereo homography, ground plane stereo or inverse perspective mapping use homography induced by a known ground plane, such that any deviation from the ground plane assumption in an image sequence is detected as an obstacle. This approach has been widely used in environments that exhibit a dominant ground plane, such as in the highway or indoor ground vehicle community, however the ground plane assumption is not relevant for aerial vehicles.

Flow divergence methods rely on the observation that objects on a collision course with a monocular image sensor exhibit expansion or looming, such that an obstacle projection grows larger on the sensor as the collision distance closes. This expansion is reflected in differential properties of the optical flow field, and is centered at the focus of expansion (FOE). The FOE is a stationary point in the image such that expansion rate from the FOE or positive divergence is proportional to the time to collision. Flow divergence estimation can noisy due to local flow correspondence errors and the amplifying effect of differentiation, so techniques rely on various assumptions to improve estimation accuracy. These include assuming a linear flow field due to narrow field of view during terminal approach, assuming known camera motion and positioning the FOE at image center, or known obstacle boundaries for measurement integration. These strong assumptions limit the operational envelope, which have lead some researchers to consider the qualitative properties of the motion field rather than metric properties from full 3D reconstruction as sufficient for collision detection. However, this does not provide a measurement of time to collision and does not localize collision obstacles in the field of view.

Insect vision research on the locust, fly and honeybee show that these insects use differential patterns in the optical flow field to navigate in the world. Specifically, research has shown that locusts use expansion of the flow field or “looming cue” to detect collisions and trigger a jumping response. This research has focused on biophysical models of the Lobula Giant Movement Detector (LGMD), a wide-field visual neuron that responds preferentially to the looming visual stimuli that is present in impending collisions. Models of the LGMD neuron have been proposed which rely on a “critical race” in an array of photoreceptors between excitation due to changing illumination on photoreceptors, lateral inhibition and feedforward inhibition, to generate a response increasing with photoreceptor edge velocity. Analysis of the mathematical model underlying this neural network shows that the computation being performed is visual field integration of divergence for collision detection, which is tightly coupled with motor neurons to trigger a flight response. This shows that insects perform collision detection, not reconstruction. This model has been implemented on ground robots for experimental validation, however the biophysical LGMD neural network model has been criticized for lack of experimental validation, and robotic experiments have shown results that do not currently live up to the robustness of insect vision, requiring significant parameter optimization and additional flow aggregation schemes for false alarm reduction. While insect inspired vision is promising, experimental validation in ground robotics has shown that there are missing pieces. Specifically, Graham argues “[this model] ignores integration over the visual field . . . how do inputs (to LGMD) become related to angular size and velocity?”. This aggregation or grouping of flow consistent with collision has shown to be a critical requirement to a successful model.

### SUMMARY

The present invention is directed to a method and system for visual collision detection and estimation of stationary objects using expansion segmentation. The invention combines visual collision detection to localize significant collision danger regions in forward looking imaging systems (such as aerial video), with optimized time to collision estimation within the collision danger region. The system and method can use expansion segmentation for the labeling of “collision” and “non-collision” nodes in a conditional Markov random field. The minimum energy binary labeling can be determined in an expectation-maximization framework to iteratively estimate labeling using the min-cut of an appropriately constructed affinity graph, and the parameterization of the joint probability distribution for time to collision and appearance. This joint probability can provide global model of the collision region, which can be used to estimate maximum likelihood time to collision over optical flow likelihoods, which can be used to aid with local motion correspondence ambiguity.

The present invention is directed to a system and method for visual collision detection suitable for unmanned vehicles, including unmanned aircraft systems (UAS) and unmanned ground vehicles. This system uses a forward looking optical video camera to capture video of the vehicle approaching a potential collision obstacle. In accordance with one embodiment of the invention, this video can be processed using the new technique called “expansion segmentation” to identify both dangerous and non-dangerous regions in the video, where “danger” is defined as those regions in the image that contain obstacles which exhibit collision dangers—because the vehicle, on its current path or trajectory, is deemed likely to collide with the obstacle. The video is further processed to determine the “time to collision” for the dangerous regions, where the time to collision is the number of seconds until that dangerous region (or obstacle) in the video will collide with the vehicle in order to prioritize the dangers and determine the closest obstacles to be avoided first. Those dangerous regions are potential collisions which must be avoided for safe navigation, and those regions that are safe are suitable for maneuvering. This system can use inertial information, such as measurements from an onboard inertial measurement unit which provides the measurements of velocity, acceleration and angular rates velocity or acceleration of the UAV, to aid in the dangerous/non-dangerous image processing—collision detection and estimation.

The present invention can be implemented in any unmanned autonomous vehicle, whether it is airborne or ground based. The UAV can include a propulsion system, for example an engine and one or more wheels or tracks, glides or skis; a turbine or propeller and wings; or an engine and rotor (e.g. a helicopter) to propel the UAV through space. The UAV can further include a camera for capturing a sequence of still images or video and a system for providing inertial information (linear and angular velocity and acceleration), such as an inertial navigation system or a GPS (global positioning system). The UAV can also include a system for communicating with a remote station and be capable of transmitting the camera images or video and inertial information to the remote station and capable of receiving control and guidance information from the remote station. The remote station can be either stationary or mobile.

In one embodiment of this system, video and telemetry (inertial measurements) are collected on board the UAV then transmitted wirelessly down to a ground control station on which the operator controls and monitors the UAV. This video and telemetry is processed on a CPU or similar data processing system to determine collision dangers, then an appropriate avoidance maneuver is transmitted wirelessly back to the vehicle. In an alternate embodiment, the video and telemetry can be processed onboard the vehicle using a CPU, DSP or FPGA optimized for visual collision detection and the results can be used by the same CPU (or transmitted locally to a separate CPU responsible) for vehicle control and guidance.

Expansion Segmentation involves a process of segmenting each sequential image in a video stream into regions of large expansion or “looming,” which manifests as an object gets closer to the camera. In accordance with one embodiment, corresponding regions from sequential images can be compared to identify those regions that are expanding or features that are expanding. Features (for example, texture, contours and edges) can be compared, video frame to video frame, and those features that are expanding can be grouped together as a region. In addition, regions in prior frames can be used to aid in identifying regions in subsequent frames. The regions that expand most rapidly can be considered to correspond to the closest object and thus the most likely danger of a collision with the UAV. The rate of expansion or how quickly a region expands or “looms larger” in the video is proportional to how long it will take for that object to collide with the camera, and from this expansion rate the time to collision can be computed. The regions that exhibit expansion can be selected based on image features that exhibit contrast such as strong contours (for example, the outline of an object), texture, edges, corners, etc. In one embodiment, the image is segmented into a rectangular matrix of regions. In another embodiment, the image is segmented into groupings of pixels. In one embodiment, the system can evaluate the distance between corresponding points (pixels or elements) on an object in sequential images in order to estimate a time to collision with the object in the images. The distance can be measured and evaluated in 1, 2 or 3 dimensions.

It is one object of the invention to use expansion segmentation theory and experimental results as a new approach simultaneous collision detection and estimation in a correspondenceless framework.

It is another objection of the invention to derive visual time to collision estimation using inertial aiding.

It is another objection of the invention to derive a time to collision uncertainty model showing inertial aiding is useful to detect small obstacles in urban flight It is another object of the invention to make explicit use of derived time to collision uncertainty model within the expansion segmentation framework.

These and other capabilities of the invention, along with the invention itself, will be more fully understood after a review of the following figures, detailed description, and claims.

### BRIEF DESCRIPTION OF THE FIGURES

FIG. 1 is a diagrammatic view of a system according to one embodiment of the invention.

FIG. 2 is a diagrammatic view of a system according to an alternative embodiment of the invention.

FIG. 3 is a diagram showing Epipolar geometry for time to collision estimation in accordance with the invention.

FIG. 4 shows a flow diagram of a method of collision detection and estimation in accordance with the invention.

FIG. 5 are diagrams which represent the time to collision theoretical uncertainty (top) and the Standard deviation of time to collision measurements (bottom) of an obstacle at 200 m (right) and 20 m (left) as a function of image position determined by a system in accordance with the invention.

FIG. 6 includes diagrams and images that show expansion segmentation results. Collision detection is shown as semi-transparent overlays with yellow, orange to red color encoding the time to collision estimate. The top row shows descend and climb performance in a simulated urban environment called “Megacity.” The middle row shows Bank turn performance in Megacity. And the bottom row shows qualitative expansion segmentation results on operational video and telemetry.

### DETAILED DESCRIPTION OF PREFERRED EMBODIMENTS

The present invention is directed to a method and system for collision detection and estimation. In accordance with one embodiment of the invention, system (in accordance with the method of the invention), using images and inertial aiding, formulates a detection of collision dangers, an estimate of time to collision for detected collision dangers, and provides an uncertainty analysis for this estimate.

In accordance with the invention, a moving vehicle, such as a UAS, MAV, a surface vehicle traveling on the ground or water uses images generated by an image source, such as a still or video camera to detect stationary objects in the path of motion of the vehicle and determine an estimate of the time to collision, should the vehicle remain on the present path. The collision detection and estimation system uses inertial information from an inertial information source, such as an inertial measurement unit (IMU) to determine constraints on corresponding pixels between a first and second image and estimate a time to collision for each pixel. In accordance with the invention, the time to collision is the amount of time (e.g. seconds) that an object represented by the pixel will intersect an infinite image plane that is parallel to the image plane of the second image and at predefined distance from the vehicle. In one embodiment, the vehicle is defined by a rectangular box that enclose the vehicle and has one surface in the infinite image plane. In an alternative embodiment, the infinite image plane is co-extensive with the second image plane. In accordance with the invention, the system can identify a pixel, a set of pixels or one or more regions within the second image that represent stationary objects determined to be a potential collision threat.

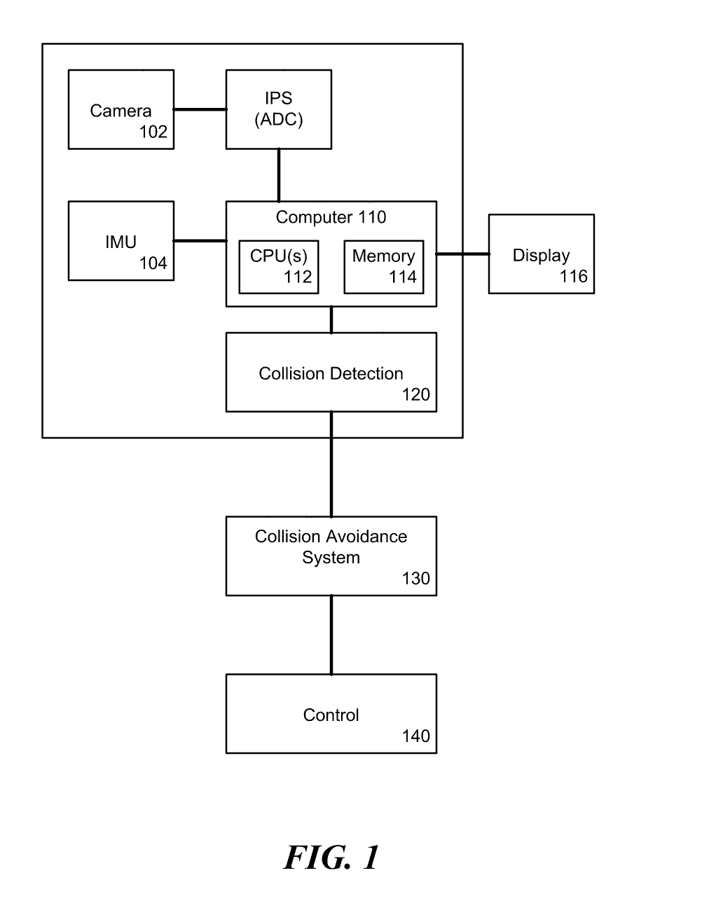

FIG. 1 shows a block diagram of a system 100 for detecting collision threats and estimating a time to collision for each threat. The system includes an image source, such as a camera 102 and an inertial information source, such as IMU 104 mounted to the frame of the vehicle (not shown). In this embodiment, the system 100 can further include a computer system 120 and an image processing system 106 connecting the camera 102 to the computer system 100. The IMU 104 can also be connected to the computer system 120 to provide inertial reference data to the computer system 120. The computer system 110 can include one or more CPUs 112 and associated memory 114, including volatile and non-volatile memory devices and systems. The computer system 110 can also include one or more computer programs, stored in memory, adapted to control the computer system 110 to process the image data received from the camera 102 and the inertial information from the IMU 104. One of the programs can include a collision detection and estimation module 120 in accordance with the invention. The collision detection module 120 can be connected to a collision avoidance system 130 which can be connected to controllers or actuators 140 that operate the control surfaces or steering components of the vehicle to control the direction of motion of the vehicle. The computer system 110 can also be connected to a display 116 to display video, image data and as part of a user interface to control the operation of the vehicle. Other user interface components, such as a keyboard and mouse can be provided. Alternatively, the display 116 can include a touch screen as well.

The collision detection and estimation module 120 can include various modules and submodules. For example, the collision detection and estimation module 120 can include an image convolution module that includes steerable filters or wavelet filters to perform image convolution and/or feature detection and produce image convolution data and image feature and edge detection information. The collision detection and estimation module 120 can include a phase correlation module for use in hypothesizing matching pixels from two or more images. The collision detection and estimation module 120 can include a feature detection module which includes one or more filters for detecting features within one or more images and producing information about features detected. The collision detection and estimation module 120 can include an expansion segmentation module for grouping and smoothing the collision pixel regions. The expansion segmentation module can process hypothesized pixel matching data and time to collision estimate and uncertainty data to identify collision regions. The collision detection and estimation module 120 can include a clustering modules, such as spectral clustering module or greedy clustering module to provide segmentation functions. The collision detection and estimation module 120 can include time to collision estimation module for determining an estimation of the time to collision of an object represented by one or more pixels in an image and a time to collision uncertainty module for determining an uncertain value for the corresponding time to collision value determined.

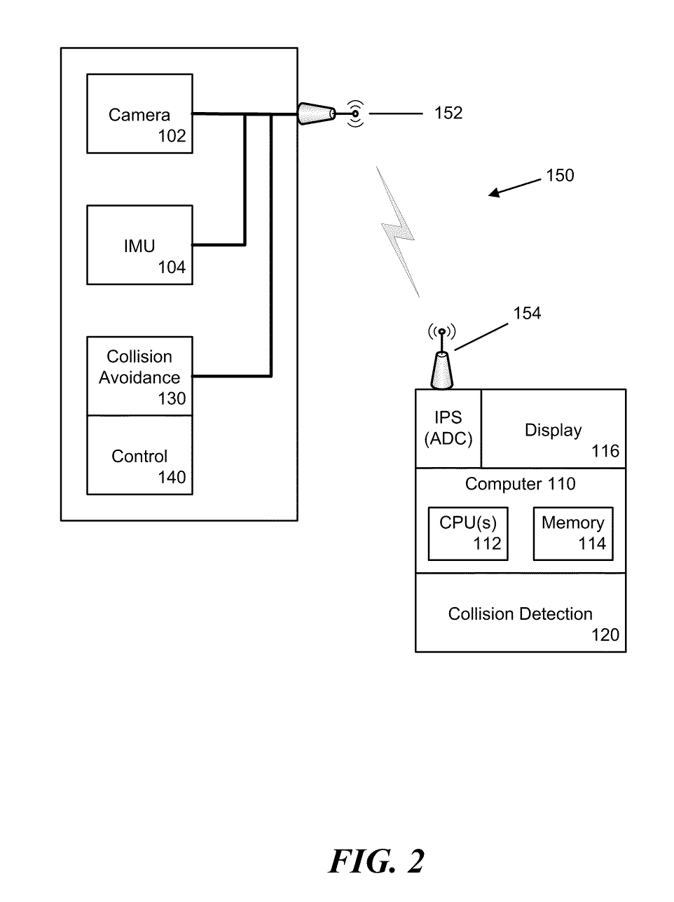

FIG. 1 shows a system in which the collision detection processing is provided by an on-board system carried by the vehicle. In alternative embodiments, such as FIG. 2, some of the components of the system are remotely located from the vehicle, reducing the vehicle payload. Similar to the embodiment shown in FIG. 1, the system 200 shown in FIG. 2 includes an image source, such as a camera 102 and an inertial information source, such as IMU 104 mounted to the frame of the vehicle (not shown). The camera 102 can be connected through an image processing system 106 via a wireless communication link 150 to remotely located computer system 100. Similarly, the IMU 104 can be connected to the computer system 100 over the same or different wireless communication links 150. The vehicle can include an antenna unit 152 and the computer system 110 can include antenna unit 154 to facilitate wireless communication. The computer system 110 can include one or more CPUs 112 and associated memory 114, including volatile and non-volatile memory devices and systems. The computer system 110 can also include one or more computer programs, stored in memory, adapted to control the computer system 110 to process the image data received from the camera 102 and the inertial information from the IMU 104. One of the programs can include a collision detection and estimation module 120 in accordance with the invention. The collision detection module 120 can be connected to a collision avoidance system 130 which can be connected to controllers or actuators 140 that operate the control surfaces or steering components of the vehicle to control the direction of motion of the vehicle. The computer system 110 can also be connected to a display 116 to display video, image data and as part of a user interface to control the operation of the vehicle. Other user interface components, such as a keyboard and mouse can be provided. Alternatively, the display 116 can include a touch screen as well. In this embodiment, the collision avoidance module 130 can be part of a computer system (like computer system 110, but preferably smaller and light weight) carried by the vehicle and can communicate wirelessly through a ground control station interface in antenna unit 152 with collision detection system 120 to appropriately control the vehicle. The collision avoidance module 130 can control the actuators or control systems 140 to steer the vehicle by moving control surfaces or steering mechanisms.

In accordance with one embodiment of the invention, the camera 102 can be an NTSC CMOS or CCD camera, having a 6 mm lens and providing 752(H)×582(V) video resolution, such as a model ePTZ 10 MP Imager available from Procerus Technologies

(Vineyard, Utah) and includes an integrated analog to digital converter based image processing system 106. The camera 102 can optionally, be mounted on a TASE gimble unit available from Cloud Technologies (Hood River, Oreg.). The IMU 104 can be part of a Kestrel Autopilot system available from Procerus Technologies (Vineyard, Utah). The computer system 110 can be a person computer system, such as a Windows, Linux, Unix or Apple MacIntosh based desktop or laptop computer. The computer system can include the appropriate interfaces, including USB interface, an NTSC video interface and I²C interface for connecting the computer system 110 to the camera 102 and the IMU 104. Alternatively, the computer system can be a DSP based system such as an On-Point video processing unit (VPU) available from Procerus Technologies (Vineyard, Utah) or a TI DaVinci Series DSP (TMS320DM643x) digital media processor available from Texas Instruments, Inc. (Dallas, Tex.). In one embodiment, the DSP base system includes 32 MB of DDR2 SDRAM, 8 MB flash ROM, an I²C serial data bus interface and an NTSC video interface.

### Inertial Aided Epipolar Geometry

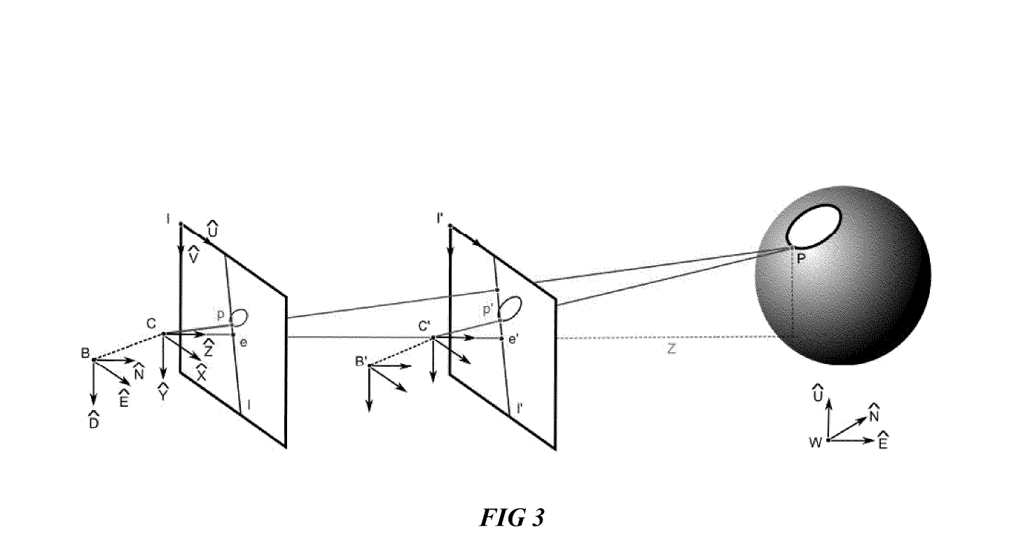

FIG. 3 shows a diagram of a calibrated camera C rigidly mounted to a body frame B of the remotely guided vehicle moving with a translational velocity V and rotational velocity Ω. The body frame moves from B to B′, and the camera C captures perspective projections I and I′ at a sampling rate tₛ of 3D point P in camera frames C and C′ respectively. The camera C is intrinsically calibrated (K), the images (I) can be lens distortion corrected, and the rotational alignment from body B to the camera _{B}^{C}R can be determined from extrinsic calibration. The body orientation _{W}^{B}R and position _{W}^{B}t can be estimated at B and B′ relative to an inertial frame W from an inertial navigation system. Using Craig notation, the relative transform between camera frames from C to C′ is

_{C}^{C′}T=(_{B′}^{C′}T_{W}^{B′}T)(_{B}^{C}T_{W}^{B}T)⁻¹

where _{C}^{C′}R is the upper 3×3 submatrix of _{C}^{C′}T. Define a rotational homography H=K(_{C}^{C′}R)K⁻¹, and the projection matrix (_{W}^{C}P) which is the upper 3×4 submatrix of (_{W}^{C}T)=(_{B′}^{C′}T_{W}^{B′}T), then the focus of expansion or epipole e=K(_{W}^{C}P)(_{W}^{B′}t) which is the projection of the origin of C in C′. Given an estimate of the essential matrix E=_{C}^{C′}T_{C}^{C′}R from inertial aided epipolar geometry, compute the epipolar line l′=K^{-T}EK⁻¹p, such that corresponding points p and p′ which are constrained to fall on epipolar lines l and l′. Finally, the time to collision (τ′) relative to C′ to P is:

$${τ}^{′} = \frac{Z}{V} = \frac{{( p - e )}^{T} ( p - e )}{{( p - e )}^{T} ( {p}^{′} - Hp )} {t}_{s} \qquad ( 1 )$$

where the rotation compensating homography Hand epipole e are determined from inertial aiding.

Intuitively, the time to collision τ′ is determined by the distance of a point p from the epipole divided by the rate of expansion from the epipole due to translation only, with rotational effects removed. τ′ is completely determined from image correspondences p and p′ as well as inertial aided measurements H, e and sampling rate tₛ. Note that in this formulation, “collision” is defined as the time required for point P to intersect with an infinite image plane at instantaneous velocity V, which depending on the extent of the vehicle body may or may not pose an immediate collision danger on the current trajectory. The full derivation of equation (1) follows directly from the motion field, with rotational homography and epipole assumed known from inertial aiding.

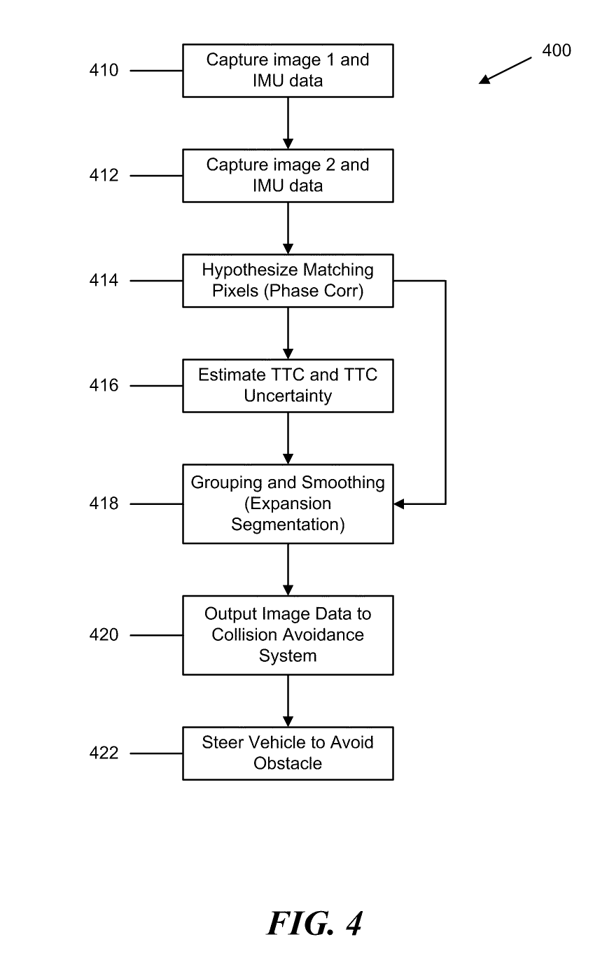

FIG. 4 shows a flow chart of a method in accordance with one embodiment of the invention. At 410, the computational system acquires a first image and the associated position and orientation data from the IMU and at 412, the computational system acquires a second image and the associated position and orientation data from the IMU. At 410 and 412, the computational system, as part of the image acquisition process, can perform image correction or compensation, to correct for image defects, such as lens distortion. At 414, the computational system compares the first image and the second image to hypothesize matching pixels—to determine which pixels in the second image correspond to pixels in the first image. In one embodiment of the invention, the computational system can perform feature detection by convolving the two images using steerable filters or wavelet filters to identify feature edges at various orientations and scales. Next, the computational system can use phase correlation to process the convolved image data and determine corresponding pixels from one image frame to the next. At 416, for each pixel in the second image, the pixel motion is determined and based upon the pixel motion, an estimate of the time to collision (TTC) τ and a TTC uncertainty can be determined. For each pixel in the second image, an estimate of the time to collision (TTC) value (τ) and an uncertainty value (σ) is determined and associated with that pixel. The pixel data and the time to collision values associated with that pixel can be stored in a database or predefined data structure in memory.

At 418, a grouping and smoothing process can use the hypothesized pixel matches and TTC estimates to apply a binary label to each pixel based on a time to collision threshold and a model the uncertainty of the time to collision value for that pixel. The time to collision threshold can be arbitrary value selected as a function of the navigational environment. While a larger threshold provides more time to avoid obstacles, smaller thresholds are better suited for more dense environments, such as urban environments where closely spaced obstacles need to be avoided. The binary label, for example, dangerous or non-dangerous, collision or non-collision or, alternatively binary 1 or binary 0, can be associated with each pixel in the database or predefined data structure. In some embodiments, the grouping and smoothing can be accomplished using expansion segmentation and conditional Markov Random Field analysis. In other embodiments, the grouping and smoothing can be accomplished using other segmentation algorithms such as spectral clustering or greedy clustering which provide grouping but not smoothing, or other approximate inference methods for markov random fields that do not use expectation maximization such as belief propagation.

The result of the smoothing process is that each pixel in the second image is associated with one of two binary labels (collision or non-collision) and a time to collision value. This data can be provided to a collision avoidance system at 420 and used to plan a path or select a change in direction to avoid approaching obstacles. In some embodiments, the collision avoidance system can project the current path of the vehicle to the closest obstacle and select a change in direction that avoids the obstacle and directs the vehicle into free space.

In some embodiments of the invention, various calibration operations can be performed to calibrate the system for subsequent operation. For example, the system can be calibrated to compensate for camera lens distortion using, for example, Bouguet calibration techniques. This can include offline calibration processes to determine the parameters used to correct for distortion.

In accordance with one or more embodiments of the invention, this process can be repeated as fast as possible to detect and avoid collisions. The processing speed is likely to be limited by the camera performance and the computational processing speed to perform the smoothing operations (e.g., expansion segmentation) and detect collision regions. In some embodiments, the collision detection process speed can range from a few milliseconds or faster, such as for dense urban environments, to 5 seconds or more, such as for more open environments.

As a person of ordinary skill will appreciate, the process can be optimized by varying the system constraints and parameters. Thus, for example, parameters such as the time to collision threshold and the collision detection cycle time can adjusted to accommodate a range of environments and performance goals. For example, longer time to collision thresholds can be used to compensate for longer collision detection cycle times. In alternative embodiments of the invention, the system can process less than all the pixels in an image frame or group pixels into pixel units (2×2 or 3×3, etc.) in order to reduce the computational load. In still other embodiments of the invention, only specific regions within the image frame, such as a region encompassing the center of the frame or the focus of expansion need be analyzed as discussed herein. In other embodiments, the computational system can vary the hypothesized feature correspondence search using bounds on prior knowledge of scene structure and can vary the phase correlation support window size to be smaller to increase processing speed. Further, the computational system can change the number of nodes in the underlying markov network using software foveation to increase processing speed and/or can use knowledge of the location of the ground plane for low altitude flight to improve smoothing and increase processing speed.

### Time to Collision Uncertainty Analysis

Without loss of generality, the epipole e can be defined at the image origin, such that equation (1) simplifies to τ=p/\dot{p}, where p is the Euclidean distance from the origin, and \dot{p}=v is the radial rate of expansion along epipolar lines due to translation only. Model p as a Gaussian random variable with parameterization N(μₚ,σₚ²), such that the variance σₚ² is determined from the expected subpixel accuracy of p. Model v as a difference two Gaussian random variables p′ and p, forming a discrete approximation to the temporal derivative. Assuming independent measurements, a difference of Gaussians can be modeled with parameterization

N(μᵥ,σᵥ²)=N(μ_{p′},2σₚ²).

Consider a first order Taylor series expansion of τ which is a function τ(p,v) about the point (μₚ,μᵥ).

$$τ \approx τ ( {μ}_{p} , {μ}_{v} ) + ( p - {μ}_{p} ) \frac{\partial τ ( {μ}_{p} , {μ}_{v} )}{\partial p} + ( v - {μ}_{v} ) \frac{\partial τ ( {μ}_{p} , {μ}_{v} )}{\partial v} \qquad ( 2 )$$

The variance σ_{τ}² of the time to collision about the point (μₚ,μᵥ) is given by the expectation

σ_{τ}²=E[(τ−τ(μₚμᵥ))²] (3)

Simplifying equation (3) using the Taylor series approximation in equation (2) results in

$${σ}_{τ}^{2} = \frac{{μ}_{v}^{2} {σ}_{p}^{2} + {μ}_{p}^{2} {σ}_{v}^{2}}{{μ}_{v}^{4}} \qquad ( 4 )$$

Equation (4) is the uncertainty for a single point projection p, due to subpixel pixel quantization error. Equation (4) is a first order approximation for the time to collision variance in terms of the Gaussian parameterization of position and expansion measurements. This variance estimate does not imply that τ is Gaussian. In fact, τ follows a ratio distribution, for which the variance approximation should be interpreted as a guide for the relative accuracy of time to collision measurements as determined from the second moment of a ratio distribution, rather than providing any probabilistic guarantees.

The time to collision uncertainty in equation (4) can also be due to epipolar geometry errors in addition to pixel quantization errors. This error is dominated by errors in the epipole location, however since the derivation assumes without loss of generality that the epipole is at the origin, epipole errors are modeled as appropriate increases of σₚ and σᵥ.

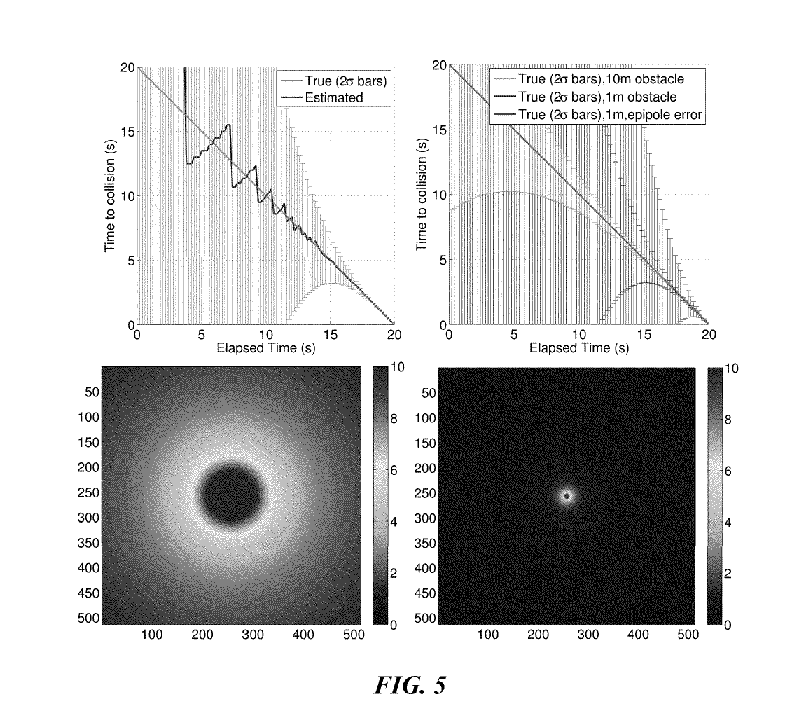

FIG. 5 (top left) shows an example of the time to collision uncertainty model in equation (4). In this example, a camera is moving at constant velocity along the optical axis such that it will collide with an obstacle in 20 seconds. The green plot shows the true (linear) time to collision along with 2^{σ} a uncertainty as determined from equation 4 for a fixed point on the obstacle 1 m orthogonal to the optical axis. The blue curve shows the estimated time to collision assuming 0.25 subpixel interpolation accuracy and focal length f=1000 pixels. Notice that the estimate exhibits a characteristic “staircase” pattern, which is due to the pixel quantization for p changing faster than \dot{p} at large TTC, however the effects of quantization are reduced as the collision distance closes. FIG. 5 (bottom) shows the standard deviation from equation (4) as a function of image position, which shows that for an obstacle at constant distance, the uncertainty significantly increases nearer to the focus of expansion and for closer obstacles. Finally, FIG. 5 (top right) shows three time to collision uncertainty plots for a 10 m obstacle, 1 m obstacle and 1 m obstacle with uncertainty in epipolar geometry. Urban obstacles such as traffic lights, poles, and signs (not including wires) are commonly of the order of 1 m the largest dimension. This plot shows that the uncertainty model down to 1 m obstacles are reasonably accurate at approximately 7 s to collision. However, if the epipolar geometry is determined from online egomotion estimates rather than inertial aiding, then the location of the epipole may deviate (in our experience) by approximately 0.5° CEP.

From this analysis, we can draw two conclusions. First, inertial aiding is useful for practical urban flight which may contain objects smaller than 1 m. Second, TTC exhibits an anisotropic uncertainty based on image position as shown in FIG. 5 (bottom), and the TTC estimates are sensitive to subpixel correspondence errors at larger standoff distances. Therefore, due to the magnitude of these errors, appropriate modeling during time to collision estimation is useful to achieve accuracy for safe flight.

### Expansion Segmentation

In accordance with one or more embodiments of the invention, expansion segmentation can be used in visual collision detection to find dangerous collision regions in inertial aided video while optimizing time to collision estimation within these regions. Expansion segmentation provides for a grouping of pixels into collision and non-collision regions using joint probabilities of expanding motion and color, determined from a minimum energy binary labeling of “collision” and “non-collision” of a conditional Markov random field in an expectation-maximization framework. The regions that correspond to closer objects will expand faster that regions corresponding to more distant objects, thus the system according to the invention can include a process for evaluation the expansion of one or more regions in sequential images or video taken by a moving vehicle to identify the closer objects that present a collision danger based on inertial information, for example, the current path or trajectory of the vehicle.

In accordance with one or more embodiments of the invention, this method provides both collision detection and estimation, where the detection provides an aggregation or grouping of all significant expansion in an image. This approach does not assume known structure or known obstacle boundaries. In addition, this method handles the geometric time to collision uncertainty discussed above by incorporating the uncertainty model into the detection and estimation framework. Further, this method handles sensitivity to local correspondence errors by using motion correspondence likelihoods rather than discrete correspondences. The global joint probability of time to collision and color for the detected danger region is used to aid in local correspondence. This approach is a correspondenceless method, as it does not rely on a priori correspondences as input. The various embodiments in accordance with the invention use the time to collision uncertainty model during labeling and region parameterization, and use correspondenceless motion likelihoods.

Given two images I and I′ with epipolar geometry H and e as determined from inertial aiding, expansion segmentation is a minimum energy solution to

$$E ( f , θ ) = {\sum }_{i ∈ I} D ( {f}_{i} , θ ; H , e , {δ}_{i} , {τ}_{c} , {t}_{s} ) + {\sum }_{( i , j ) ∈ N} V ( {f}_{i} , {f}_{j} ; γ ) \qquad ( 5 )$$

over both binary labels fᵢε{0,1} for each of N pixels resulting in an image labeling f={f₀, f₁, . . . f_{N}} in I. The labeling fᵢ=0 corresponds to “collision”, and fᵢ=1 to “non-collision”. θ={θ_{c},θₛ} is a global parameterization for joint probability of collision labeled features (θ_{c}) and non-collision labeled or “safe” features (θₛ). These joint probability distributions are defined over image feature measurements Z modelled as a mixture of Gaussians, such that for all measurements Zᵢ with label fᵢ=0:

$$p ( z \vert {θ}_{c} ) = {\sum }_{i} {α}_{i} exp ( - {( {z}_{i} - {μ}_{i} )}^{T} {\sum }_{i}^{- 1} ( {z}_{i} - {μ}_{i} ) ) \qquad ( 6 )$$

where αᵢ are normalized mixture coefficients and θ_{c}={μ₁, Σ₁, . . . , μₖ, Σₖ} is a parameterization for a mixture of k Gaussians of the joint distribution of image measurements Z which have label 0 (“collision”). p(z|θₛ) is defined similarly for measurements with label 1 (“safe”). The number k is determined by the total number of measurements in an overcomplete manner This global model makes the strong assumption that given the current image, measurements (e.g. TTC and color) are correlated, and this correlation is reflected in the joint and can be used to resolve local correspondence ambiguities. This assumption does not hold in general, and can result in errors, however there is a fundamental tradeoff between the complexity of the global model and the promise of real time performance.

D in equation (5) is the data term which encodes the cost of assigning label “collision” or “non-collision” fᵢ to iεI, given global parameterization of the joint distribution of collision feature measurements θ_{c} and non-collision θₛ. This data term requires the following additional fixed inputs: (i) H and e which are the rotational homography and epipole from inertial aided epipolar geometry, (ii) τ_{c} which is a threshold set by the operator which characterizes the time to collision at which an obstacle exhibits an operationally relevant risk, such that τ≦τ_{c} exhibits “significant” collision danger given the constraints of the vehicle and mission, (iii) tₛ is the sampling rate of images I and I′ for unit conversion of frames to collision to seconds to collision and (iv) δᵢ(i′) is a correspondence likelihood function between pixels iεI and i′εI′, such that the maximum likelihood correspondence for i is j*=argmaxⱼδᵢ(j), with correspondence likelihood δᵢ*. This function provides a motion likelihood for each pixel i, and may use inertial aided epipolar geometry to limit the domain of δᵢ. Experimental details of this function are provided below.

D in equation (5) captures the cost of assigning collision labels to a pixel i given image feature measurements. These measurements include a scalar estimate of time to collision given δᵢ(i′) with τᵢ(i′) from equation (1), and 3 luminance and chrominance components of color c. The result is a measurement vector zᵢ=[τc], for which we define two probability distributions as weighted integrals for each i:

$$P ( {τ}_{i} \leq {τ}_{c} \vert {θ}_{c} ) = {max}_{j} {δ}_{i} ( j ) {\int }_{- ∞}^{∞} p ( z \vert {θ}_{c} ) N ( {μ}_{i} , {Σ}_{i} ) d z \qquad ( 7 )$$

and P(τᵢ>τ_{c}|θₛ) respectively. This models the probability that τᵢ≦τ_{c} by integrating the joint PDF p(z|θ_{c}) from equation (6) over a Gaussian model of uncertainty of Zᵢ, where μᵢ=[τᵢcᵢ] and Σᵢ=diag(σ_{τ},σ_{c}). This is determined from equation (1) and σ_{τ} from equation (4). The result is a likelihood that the time to collision τᵢ for the ith pixel is “significant” (e.g. <τ_{c}) using the derived uncertainty model for time to collision from above. Finally, the data term D in equation (5) takes the form for binary labels f:

D=(1−fᵢ)P(τᵢ≦τ_{c}|θ_{c})+(fᵢ)P(τᵢ>τ_{c}|θₛ) (8)

Equation (7) which models TTC uncertainty for the data likelihood in equation (8) using motion likelihoods δᵢ in a correspondenceless framework is a central contribution of this work.

V in equation (5) is a function which encodes the cost of assigning labels fᵢ to i and fⱼ to j when (i, j) are neighbors in a given neighborhood set N⊂I×I′. This function represents a penalty for violating label smoothness for neighboring (i, j). In this formulation, the interaction term V takes the form of a Potts energy model with static cues based on the appearance measurement in the current image, forming a conditional random field:

V(fᵢ,fⱼ)=γT(fᵢ≠fⱼ)exp(−β|I(i)−I(j)|²) (9)

where T is 1 if the argument is true, and zero otherwise. This term will bias the labeling towards smooth labeling, with label discontinuities at edges with color differences. γ is a smoothness parameter which will encode the strength of the smoothness prior, and β is a measurement variance for color differences. Experiments show that the segmentation is insensitive to the choice of γ and for 4-neighbor connectivity, and a choice of γ=25 provides stable segmentations across a range of scenes.

The minimization of equation (5) can be performed in an expectation-maximization (EM) framework to iteratively estimate the optimal labeling f given region parameterization θ (maximization), followed by an estimate of the maximum likelihood region parameterization given the labeling (expectation). The region parameterization θ is initialized to either a uniform distribution or set to the parameterization determined from the prior segmentation result. Given θ, the labeling in equation (5) can be solved exactly for a binary labeling by posing a maximum network flow problem on a specially constructed network flow graph which encodes equation (5), for which efficient maxflow solutions are available. Then, given this labeling, the region parameterizations θ_{c} and θₛ can be updated using only measurements Zᵢ with labels f=0 and f=1 respectively. The Gaussian mixture parameters in equation (6) are exactly μᵢ=[τᵢcᵢ] and Σ=diag(σ_{τ},σ_{c}) from equation (7), with mixture coefficients αᵢ=δᵢ*. This mixture takes into account the correspondence likelihood and uncertainty of τᵢ based on the image position i.

Following convergence of the EM iteration, such that the labeling does not change significantly or a maximum number of iterations is reached, the output of expansion segmentation is the final labeling f* such that labels fᵢ=0 are “significant collision dangers” and the final collision region parameterization θ_{c}*. The maximum likelihood time to collision for measurements within the collision danger region (all i labeled fᵢ=0) can be estimated using (θ_{c}*) as follows:

$${τ}_{i}^{*} = {argmax}_{j} P ( {τ}_{i} ( j ) \leq {τ}_{c} \vert {θ}_{c}^{*} ) \qquad ( 10 )$$

for which τᵢ(j) is determined from equation (1) such that correspondence (i,j) determines \dot{p}. This estimate uses the joint θ_{c}* to estimate the maximum likelihood τᵢ given the uncertainty model of time to collision, which provides global region information to optimize over the local correspondence likelihood function δᵢ.

### Results

### Experimental Setup

Video and inertial flight data were collected by flying a Kevlar reinforced Zagi fixed wing air vehicle in near earth collision scenarios with an analog NTSC video transmitter and a Kestrel autopilot with MEMS grade IMU wirelessly downlinked to a ground control station for video and telemetry data collection. Example imagery collected is shown in FIG. 4 (bottom row).

Urban flight data collection is infeasible due to regulatory constraints of urban flight and the challenge of collecting dense ground truth. Instead, we created a custom flight simulation environment based on Matlab/Simulink and OpenSceneGraph in which to test algorithms for closed loop visual collision detection, mapping and avoidance. This provides medium fidelity rendered video of 3D models and terrain in “Megacity”, ground truth range for performance evaluation, and a validated model of inertial navigation system measurements for inertial aiding. Example imagery from Megacity are shown in FIG. 4. The ground truth range to obstacles is not shown, but is used for quantitative performance evaluation.

The experimental system to test expansion segmentation implemented the following processing chain:

1. Bouguet intrinsic camera calibration and Lobo inertial-camera extrinsic calibration

2. Preprocessing for video deinterlacing and RGB to YUV color space conversion

3. Analog video noise classification to classify noisy frames during downlink from the air vehicle

4. Scaled and oriented feature extraction using steerable filters

5. Motion likelihood from steerable filter phase correlation with inertial aiding in a correspondenceless framework

6. Expansion segmentation with maximum likelihood time to collision estimation.

The motion likelihood in step 5 is the implementation of δᵢ in equation 5. This approach uses phase correlation of quadrature steerable filter responses of two images I and I′, using inertial aiding to provide epipolar lines as constraints for correspondence. Phase correlation is implemented as a disparity likelihood within a fixed disparity range (dₘₐₓ) and orthogonal distance threshold (ρₘₐₓ) from epipolar lines. The orthogonal epipolar projection length ρ of p′ onto the epipolar line l′ is

$${ρ}^{2} = \frac{{( {p}^{′ T} Fp )}^{2}}{{‖ {\hat{e}}_{3} Fp ‖}^{2}} \qquad ( 11 )$$

ρₘₐₓ is chosen experimentally to reflect the uncertainty in the inertial aided epipolar geometry, and dₘₐₓ is chosen relative to τ_{c}. Phase correlation is computed for all epipolar inliers p′ using bilinear interpolation of features at integer disparity along epipolar lines. In equation 11, ê₃ is the cross product matrix for e₃=[001]^{T} and F is the fundamental matrix where F=K^{-T}EK⁻¹. The result is a motion likelihood function δₚ(p′) as determined from phase correlation over all inliers (p′).

Experiments with the Kestrel autopilot and MEMS grade IMU showed that the rotational homography H can be directly computed from inertial measurements, however position errors due to accelerometer biases and GPS uncertainties contribute significant error to the epipolar geometry. In this experimental system, we use a random sample of SIFT feature correspondences and sparse bundle adjustment initialized with the inertial measurement to improve the essential matrix estimate.

All results in this section were generated using the following parameters: 320×240 imagery, 9×9 steerable filter kernels, N is 4-neighbor connectivity, ρₘₐₓ=0.5, dₘₐₓ=24, 0.5 subpixel disparity, γ=25, θ is initialized to uniform distribution, and 0 in equation (7) is implemented as a joint histogram with fixed bin width rather than mixture of Gaussians. In our experience, this is a suitable approximation which does not significantly impact performance. The experimental system was implemented in C++ with Matlab MEX wrappers for data visualization, and converges in 5-12 EM iterations in approximately 5 seconds per image on a 2.2 GHz Intel Core 2 Duo. In our benchmarks, δ_{P} computation of motion likelihood dominates runtime performance and can be further optimized.

### Simulation Results

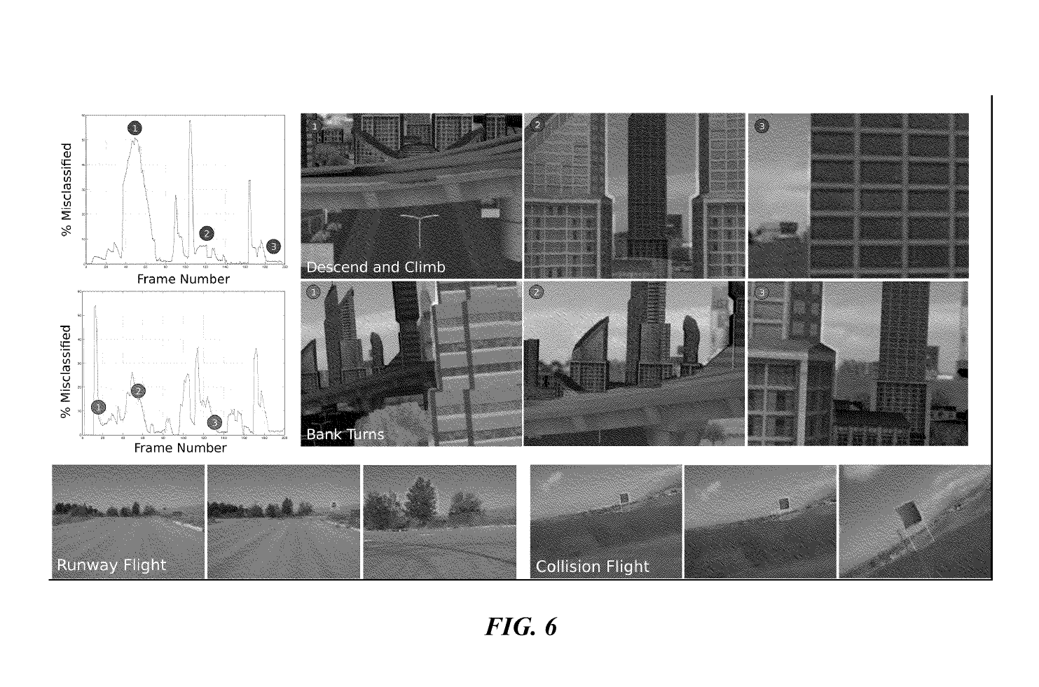

FIG. 6 shows expansion segmentation results on simulated and operational flight data. FIG. 6 (top) shows quantitative performance evaluation of a descend and climb scenario in the Megacity simulation environment. The percent misclassification is the percentage of pixels incorrectly classified as either dangerous (false positive) or safe (missed detection) for a τ_{c}=10 s relative to the ground truth. This performance metric is widely used in the evaluation of stereo algorithms and is adapted here for evaluation of time to collision. Expansion segmentation results are shown at three points in the scenario, where the color of the semi-transparent overlay encodes the mean time to collision for the danger region (yellow=far, red=close). The large percentage misclassification at frame (1) is due to the classification of the road underneath the overpass as dangerous, as it has few strong features for feature correspondence. The misclassification at frame (2) is due pixels at the border having no motion measurement resulting in a smoothing of the image border into the foreground. FIG. 6 (middle) shows a bank turn scenario in Megacity with misclassifications due to smoothing at the image border. In both scenarios, large narrow spikes in misclassification are due to the expansion segmentation not yet detecting that a large foreground region is dangerous due to time to collision uncertainty. Smaller misclassifications are due to motion ambiguity from periodic features, over-smoothing at the image edges where there are no motion measurements and time to collision uncertainty near the epipole.

### Flight Results

FIG. 6 (bottom) shows qualitative results for operational flight data. First, data was collected on a runway during takeoff, and results show that the road, trees, fence and red tarp all exhibit a significant collision danger while the central tree and right mountains are set back in the scene and therefore do not exhibit immediate collision danger and are correctly detected as “safe”. Note that collision dangers are defined as the time to intersect an infinite image plane, so peripheral trees and stop sign are correctly detected as potential collisions. Also, note that at no time is a ground plane assumption used to generate these results, and for an aerial vehicle the ground is a legitimate collision danger. The time to collision for these regions is dominated by the ground plane which has a small time to collision to intersect the infinite image plane, so therefore the color of the semi-transparent overlay is consistently red. In one simulation was conducted with a time to collision of τ_{c}=5 s and repeated with τ_{c}=8 s and it showed that the trees were detected earlier for τ_{c}=8 s. Quantitative evaluation was not performed due to a lack of ground truth for the flight sequences.

Finally, data was collected during a true collision event of a single high contrast obstacle with a human pilot in the loop for safety. The expansion segmentation results are best viewed in color and magnified in the PDF or in the associated video. This result shows that the collision danger regions are successfully segmented in full 6-DOF motion from a small UAV, and thus demonstrating proof of concept.

The use of the expansion segmentation approach can be used in other applications, including for example, target pursuit which can include nulling the effects of expansion, and expansion segmentation due to zoom for foreground/background segmentation.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system for collision detection and estimation in a moving vehicle with respect to stationary objects, the system comprising:
an image source providing a plurality of images in a direction of motion;
an inertial information source providing positional and directional information about the vehicle; and
a computer system having at least one processing unit and associated memory, the computer system being connected to the image source to receive image data and to the inertial information source to receive positional and orientation information;
wherein the memory includes computer programs adapted for use by the computer system to process image data for a first image and a second image and positional and orientation information associated with the image data to determine a time to collision value for at least one pixel in said second image as a function of the first image data, the second image data, the positional information and the orientation information.

2. The system according to claim 1 wherein at least one computer program includes a phase correlation module and the computer system uses the phase correlation module to indentify pixels in the second image that correspond to pixels in the first image.

3. The system according to claim 1 wherein at least one computer program includes a feature detection module and a phase correlation module and the computer system uses the feature detection module to detect features in the first and second images and uses the phase correlation module to indentify pixels in the second image that correspond to pixels in the first image using feature detection information.

4. The system according to claim 1 wherein at least one computer program includes a convolution module and a phase correlation module and the computer system uses the convolution module to detect features in the first and second images and uses the phase correlation module to indentify pixels in the second image that correspond to pixels in the first image using convolution information.

5. The system according to claim 1 wherein computer system determines a time to collision uncertainty for at least one pixel in the second image.

6. The system according to claim 1 wherein computer system determines a time to collision value for every pixel in the second image.

7. The system according to claim 1 wherein computer system determines a time to collision value and a time to collision uncertainty for every pixel in the second image.

8. The system according to claim 1 wherein computer system determines a time to collision value for every pixel in the second image and associates each pixel with a collision probability value as a function of the time to collision value for each pixel and a predetermined threshold.

9. The system according to claim 1 wherein computer system determines a time to collision value for every pixel in the second image and associates each pixel with a binary collision value as a function of the time to collision value for each pixel and a predetermined threshold.

10. The system according to claim 1 wherein computer system determines a time to collision value for every pixel in the second image and associates each pixel with a binary collision value as a function of the time to collision value for each pixel and a predetermined threshold and wherein at least one computer program includes an expansion segmentation module and the computer system uses the expansion segmentation module to group pixels in the second image according into one of two groups as a function of the binary collision value.

11. The system according to claim 10 wherein the expansion segmentation module uses a Markov Random Field analysis to group the pixels in the second image.

12. The system according to claim 1 further comprising a collision avoidance system, the collision avoidance being adapted and configured to change the movement of the vehicle in at least one dimension as a function of the time to collision value for at least one pixel.

13. The system according to claim 1 wherein the computer system determines a collision value for at least one pixel as a function of the time to collision value and wherein the direction of motion of the vehicle is changed as function of the collision value for at least one pixel.

14. A method of collision detection and estimate for a moving vehicle, the vehicle including an image source providing a plurality of images in a direction of motion, an inertial information source providing positional and orientation information about the vehicle and a system for processing image data, positional and orientation information, the method comprising:
retrieving first image data corresponding to a first image and positional and orientation information associated with the first image;
retrieving second image data corresponding to a second image and positional and orientation information associated with the second image; and
determining a time to collision value for at least one pixel in the second image as a function of the first image data and associated positional and orientation information and the second image data and associated positional and orientation information.

15. The method according to claim 14 further comprising:
identifying at least one pixel in the second image that corresponds to at least one pixel in the first image using phase correlation.

16. The method according to claim 14 further comprising:
detecting features in at least one image using image convolution; and
identifying at least one pixel in the second image that corresponds to at least one pixel in the first image using phase correlation and image convolution information.

17. The method according to claim 14 further comprising:
determining a time to collision uncertainty value for at least one pixel in the second image as a function of the first image data and associated positional and orientation information and the second image data and associated positional and orientation information.

18. The method according to claim 14 further comprising:
determining a time to collision value for each pixel in the second image as a function of the first image data and associated positional and orientation information and the second image data and associated positional and orientation information.

19. The method according to claim 14 further comprising:
determining a time to collision value and a time to collision uncertainty value for each pixel in the second image as a function of the first image data and associated positional and orientation information and the second image data and associated positional and orientation information.

20. The method according to claim 14 further comprising:
determining a collision probability value for each pixel in the second image as a function of the time to collision value for each pixel and a predetermined threshold.

21. The method according to claim 14 further comprising:
determining a binary collision value for each pixel in the second image as a function of the time to collision value for each pixel and a predetermined threshold.

22. The method according to claim 14 further comprising:
determining a binary collision value for each pixel in the second image as a function of the time to collision value for each pixel and a predetermined threshold and
grouping, using expansion segmentation, each pixel in the second image into one of two groups as a function of the binary collision value.

23. The method according to claim 22 further comprising using Markov Random Field analysis to group each pixel in the second image into one of two groups.

24. The method according to claim 14 further comprising:
changing a direction of movement of the vehicle as a function of the time to collision values for at least one pixel.

25. The method according to claim 14 further comprising:
determining a collision value for at least one pixel as a function of the time to collision value for at least one pixel and
changing a direction of motion of the vehicle as a function of the collision value for at least one pixel.
